(19) United States
(12) Patent Application Publication
(10) Pub. No.: US 2013/0155075 A1
(43) Pub. Date: Jun. 20, 2013

(54) INFORMATION PROCESSING DEVICE, IMAGE TRANSMISSION METHOD, AND RECORDING MEDIUM

(71) Applicant: FUJITSU LIMITED, Kawasaki-shi (JP)

(72) Inventors: Kazuki MATSUI, Kawasaki (JP); Kenichi Horio, Yokohama (JP); Ryo Miyamoto, Kawasaki (JP); Tomoharu Imai, Kawasaki (JP)

(21) Appl. No.: 13/632,183

(22) Filed: Oct. 1, 2012

(30) Foreign Application Priority Data
Dec. 15, 2011 (JP) 2011-275009

(51) Int. Cl. G06F 15/00

(52) U.S. Cl. 345/501

(57) ABSTRACT

A server device draws a processing result from software into an image memory, detects an update area containing an update between frames in an image, and compresses the image in the update area to a still image by using one of a compression format from among multiple compression formats. The server device identifies a high-frequency change area and compresses the image in the high-frequency change area to a moving image. The server device transmits still image compressed data and moving image compressed data to a client terminal. When the server device ends the compression of the moving image, it attempts to change the compression format of a still image and selects a compression format of a still image based on the result of comparing a compression ratio of still image compressed data in update areas obtained before and after a change in a compression format is attempted.

### CROSS-REFERENCE TO RELATED APPLICATIONS

This application is based upon and claims the benefit of priority of the prior Japanese Patent Application No. 2011-275009, filed on Dec. 15, 2011, the entire contents of which are incorporated herein by reference.

### FIELD

The embodiments discussed herein are related to an information processing device, an image transmission method, and recording medium.

### BACKGROUND

A system called a thin client system is known. Thin client systems are configured so that a client is provided with only a minimum of functions and resources, such as applications, and files are managed by a server.

In a thin client system, a client acts as if it actually executes processes and stores data although it is in fact the server that makes the client display results of processes executed by the server or data stored in the server.

When transmitting screen data that is displayed on the client by the server in this way, a transmission delay may sometimes occur due to congestion in the network between the server and the client. This transmission delay of the network causes the drawing of screen data transmitted from the server to be delayed on the client side. Therefore, the response to operations executed on the client side becomes worse.

As an example of a technology for reducing the amount of data of an image, there is a data compression method in which a compression ratio is adjusted by increasing or decreasing the quantization range such that the bit rate of quantized and encoded compressed data is within the targeted range of the compression ratio. There is another example of the technology that includes a remote operation system for converting, when transmitting a moving image or a still image from a terminal on the operation side to a terminal device that is remotely operated, data of the moving image or the still image in accordance with the characteristics of the terminal device, such as its communication speed or screen resolution.

Patent Document 1: Japanese Laid-open Patent Publication No. 06-237180

Patent Document 2: Japanese Laid-open Patent Publication No. 2002-111893

Patent Document 3: Japanese Laid-open Patent Publication No. 06-062257

Patent Document 4: Japanese Laid-open Patent Publication No. 06-141190

However, with the technologies described above, there is a problem in that the reduction efficiency of the amount of data transmission is reduced, as described below.

Specifically, in the data compression method or the remote operation system described above, the same compression format is always used for all screen data even though the compression ratio of images varies depending on the images to be displayed even when the same compression format is used. Accordingly, in the data compression method or the remote operation system described above, because a compression format is sometimes used that is not suitable for a screen, the effect thereof is limited even when screen data is compressed. Accordingly, the reduction efficiency of the amount of data transmission is reduced. It is conceivable that compression formats suitable for an image to be displayed on a screen can be selected from among multiple compression formats; however, to select a compression format, the image to be displayed on the screen needs to be analyzed before transmitting screen data from the server to the client. Accordingly, when a compression format used for screen data is selected from among multiple compression formats, the processing load on the server increases due to the image analyzing process described above and thus a delay occurs in the processing time, which results in a drop in the operation response.

### SUMMARY

According to an aspect of an embodiment, an information processing device includes: a memory; and a processor coupled to the memory, wherein the processor executes a process including: drawing a processing result from software into an image memory that stores therein an image to be displayed on a terminal device that is connected through a network; detecting an update area containing an update between frames in an image drawn in the image memory; performing still image compression on an image in the update area by using one of a compression format from among multiple compression formats; identifying a high-frequency change area in which a frequency of changes between the frames in the image drawn in the image memory exceeds a predetermined frequency; performing moving image compression, from among images drawn in the image memory, on an image in the high-frequency change area; transmitting still image compressed data in the update area and moving image compressed data in the high-frequency change area to the terminal device; attempting to change a compression format used at the still image compression when compression of a moving image ends at the moving image compression; and selecting a compression format used at the still image compression based on the result of comparing a compression ratio of still image compressed data in update areas obtained, at the attempting, before and after a change in a compression format.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram depicting the functional construction of each device contained in a thin client system according to a first embodiment;

FIG. 2 is a diagram depicting the outline of division of a desktop screen;

FIG. 3A is a diagram depicting the outline of determination of the change frequency of the desktop screen;

FIG. 3B is another diagram depicting the outline of determination of the change frequency of the desktop screen;

FIG. 3C is another diagram depicting the outline of determination of the change frequency of the desktop screen;

FIG. 4 is a diagram depicting the outline of correction of a mesh joint body;

FIG. 5 is a diagram depicting the outline of combination of candidates of a high-frequency change area;

FIG. 6A is a diagram depicting the outline of notification of attribute information on the high-frequency change area;

FIG. 6B is another diagram depicting the outline of notification of the attribute information on the high-frequency change area;

FIG. 6C is another diagram depicting the outline of notification of the attribute information on the high-frequency change area;

FIG. 7 is a diagram depicting a method for selecting a compression format of a still image;

FIG. 8 is a flowchart (1) depicting the flow of an image transmission process according to a first embodiment;

FIG. 9 is a flowchart (2) depicting the flow of the image transmission process according to the first embodiment;

FIG. 10 is a flowchart (3) depicting the flow of the image transmission process according to the first embodiment;

FIG. 11A is a diagram depicting the outline of an extension of map clearing;

FIG. 11B is another diagram depicting the outline of an extension of the map clearing;

FIG. 12A is a diagram depicting the outline of the suppression of the contraction of a high-frequency change area;

FIG. 12B is another diagram depicting the outline of the suppression of the contraction of the high-frequency change area; and

FIG. 13 is a diagram depicting an example of a computer for executing an image transmission program according to the first embodiment and a second embodiment.

### DESCRIPTION OF EMBODIMENTS

Preferred embodiments will be explained with reference to accompanying drawings. The disclosed technology is not limited to the embodiments. Furthermore, the embodiments can be appropriately used in combination as long as processes do not conflict with each other.

### [a] First Embodiment

System Construction

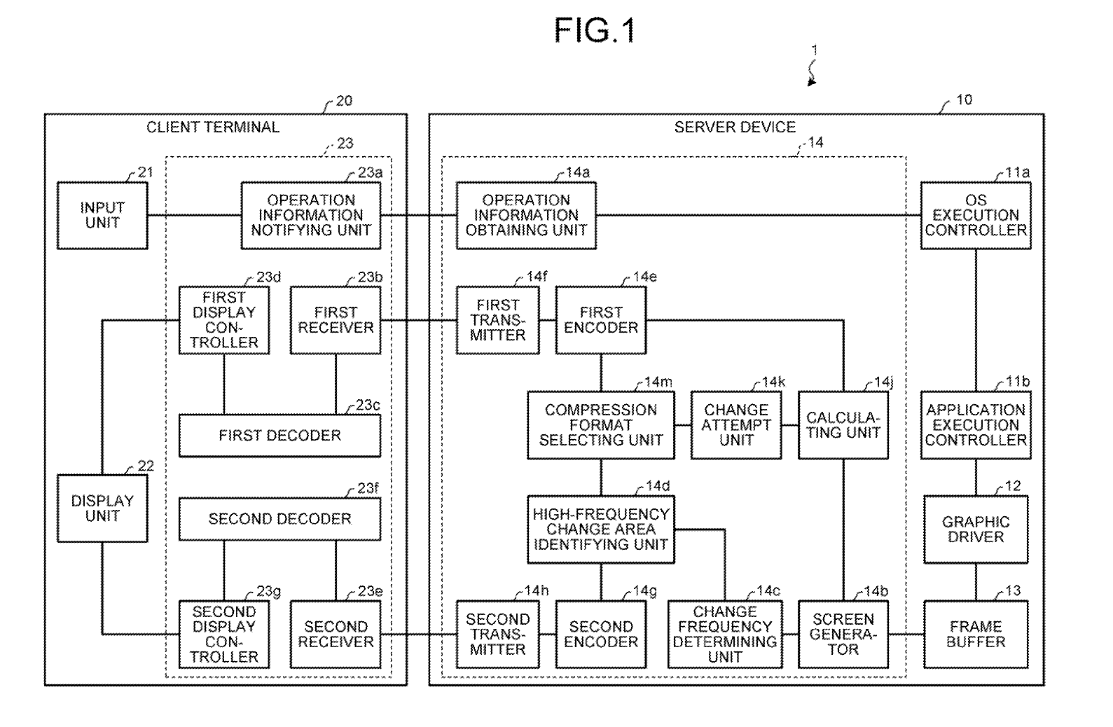

First, the construction of a thin client system according to the present embodiment will be described. FIG. 1 is a block diagram depicting the functional construction of each device contained in the thin client system according to the first embodiment.

In a thin client system 1, as depicted in FIG. 1, the screen (display frame) displayed by a client terminal 20 is remotely controlled by a server device 10. That is, in the thin client system 1, the client terminal 20 acts as if it actually executes processes and stores data although it is in fact the server device 10 that makes the client terminal 20 display results of processes executed by the server device 10 and data stored in the server device.

As depicted in FIG. 1, the thin client system 1 has the server device 10 and the client terminal 20. In the example of FIG. 1, one client terminal 20 is connected to one server device 10. However, any number of client terminals may be connected to one server device 10.

The server device 10 and the client terminal 20 are connected to each other through a predetermined network so that they can mutually communicate with each other. Any kind of communication network, such as the Internet, LAN (Local Area Network) and VPN (Virtual Private Network), may be adopted as the network irrespective of the network being wired or wireless. It is assumed that an RFB (Remote Frame Buffer) protocol in Virtual Network Computing (VNC) is adopted as the communication protocol between the server device 10 and the client terminal 20, for example.

The server device 10 is a computer that supplies a service to remotely control a screen that is to be displayed on the client terminal 20. An application for remote screen control for servers is installed or pre-installed on the server device 10. In the following description, the application for remote screen control for servers will be referred to as “the remote screen control application on the server side”.

The remote screen control application on the server side has a function of supplying a remote screen control service as a basic function. For example, the remote screen control application on the server side obtains operation information at the client terminal 20 and then makes an application operating in the device on the server side execute processes requested by the operation based on the operation information. Furthermore, the remote screen control application on the server side generates a screen for displaying results of the process executed by the application and then transmits the generated screen to the client terminal 20. At this point, the remote screen control application on the server side transmits the area that is changed and that corresponds to an assembly of pixels at a portion at which a bit map image displayed on the client terminal 20 before a present screen is generated, i.e., the remote screen control application on the server side transmits an image of an update rectangle. In the following description, a case where the image of the updated portion is formed as a rectangular image will be described as an example. However, the disclosed device is applicable to a case where the updated portion has a shape other than that of a rectangular shape.

In addition, the remote screen control application on the server side also has a function of compressing data of a portion having a large inter-frame motion to compression type data suitable for moving images and then transmitting the compressed data to the client terminal 20. For example, the remote screen control application on the server side divides a desktop screen to be displayed by the client terminal 20 into multiple areas and monitors the frequency of changes for each of the divided areas. At this point, the remote screen control application on the server side transmits attribute information on an area having a change frequency exceeding a threshold value, i.e., a high-frequency change area, to the client terminal 20. In addition to this process, the remote screen control application on the server side encodes the bit map image in the high-frequency change area to Moving Picture Experts Group (MPEG) type data, e.g., MPEG-2 or MPEG-4, and then transmits the encoded data to the client terminal 20. In the embodiment, the compression to the MPEG (Moving Image Experts Group) type data is described as an example. However, this embodiment is not limited to this style, and, for example, any compression encoding system such as Motion-JPEG (Joint Photographic Experts Group) may be adopted insofar as it is a compression type suitable for moving images.

The client terminal 20 is a computer on a reception side that receives a remote screen control service from the server device 10. A fixed terminal such as a personal computer or a mobile terminal such as a cellular phone, PHS (Personal Handyphone System) or PDA (Personal Digital Assistant) may be adopted as an example of the client terminal 20. A remote screen control application suitable for a client is installed or pre-installed in the client terminal 20. In the following description, the application for remote screen control for a client will be referred to as a “remote screen control application on the client side”.

The remote screen control application on the client side has a function of notifying the server device 10 of operation information received through various kinds of input devices, such as a mouse and a keyboard. For example, the remote screen control application on the client side notifies the server device 10, as operation information, of right or left clicks, double clicks or dragging by the mouse and the amount of movement of the mouse cursor obtained through a moving operation of the mouse. For another example, the amount of rotation of a mouse wheel, the type of pushed key of the keyboard and the like are also notified to the server device 10 as operation information.

Furthermore, the remote screen control application on the client side has a function of displaying images received from the server device 10 on a predetermined display unit. For example, when a bit map image of an update rectangle is received from the server device 10, the remote screen control application on the client side displays the image of the update rectangle while the image concerned is positioned at a changed portion of the previously displayed bit map image. For another example, when attribute information on a high-frequency change area is received from the server device 10, the remote screen control application on the client side sets the area on the display screen corresponding to the position contained in the attribute information as a blank area that is not a display target of the bit map image (hereinafter referred to as an “out-of-display-target”). Under this condition, when receiving the encoded data of the moving image, the remote screen control application on the client side decodes the data concerned and then displays the decoded data on the blank area.

Construction of Server Device

Next, the functional construction of the server device according to this embodiment will be described. As depicted in FIG. 1, the server device 10 has an OS execution controller 11a, an application execution controller 11b, a graphic driver 12, a frame buffer 13, and a remote screen controller 14. In the example of FIG. 1, it is assumed that the thin client system contains various kinds of functional units provided to an existing computer, for example, functions such as various kinds of input devices and display devices in addition to the functional units depicted in FIG. 1.

The OS execution controller 11a is a processor for controlling the execution of an OS (Operating System). For example, the OS execution controller 11a detects a start instruction of an application and a command for the application from operation information that is obtained by an operation information obtaining unit 14a, described later. For example, when detecting a double click on an icon of an application, the OS execution controller 11a instructs the application execution controller 11b, described later, to start the application corresponding to that icon. Furthermore, when detecting an operation requesting execution of a command on an operation screen of an application being operated, i.e., on a so called window, the OS execution controller 11a instructs the application execution controller 11b to execute the command.

The application execution controller 11b is a processor for controlling the execution of an application based on an instruction from the OS execution controller 11a. For example, the application execution controller 11b operates an application when the application is instructed to start by the OS execution controller 11a or when an application under operation is instructed to perform a command. The application execution controller 11b requests the graphic driver 12, described later, to draw a display image of a processing result obtained through the execution of the application on the frame buffer 13. When the graphic driver 12, as described above, is requested to draw, the application execution controller 11b notifies the graphic driver 12 of a display image together with the drawing position.

The application executed by the application execution controller 11b may be pre-installed or installed after the server device 10 is shipped. Furthermore, the application may be an application operating in a network environment such as JAVA (registered trademark).

The graphic driver 12 is a processor for executing a drawing process on the frame buffer 13. For example, when accepting a drawing request from the application execution controller 11b, the graphic driver 12 draws the display image as a processing result of the application in a bit map format at a drawing position on the frame buffer 13 that is specified by the application. In the above, a case has been described as an example in which the drawing request is accepted via the application. However, a drawing request may be accepted from the OS execution controller 11a. For example, when accepting a drawing request based on the mouse cursor movement from the OS execution controller 11a, the graphic driver 12 draws a display image based on the mouse cursor movement in a bit map format at a drawing position on the frame buffer 13 that is indicated by OS.

The frame buffer 13 is a memory device for storing a bit map image drawn by the graphic driver 12. A semiconductor memory element such as a video random access memory (VRAM), a random access memory (RAM), a read only memory (ROM), or a flash memory is known as an example of the frame buffer 13. A memory device such as a hard disk or an optical disk may be adopted as the frame buffer 13.

The remote screen controller 14 is a processor for supplying a remote screen control service to the client terminal 20 through the remote screen control application on the server side. As depicted in FIG. 1, the remote screen controller 14 has the operation information obtaining unit 14a, a screen generator 14b, a change frequency determining unit 14c, and a high-frequency change area identifying unit 14d. Furthermore, the remote screen controller 14 has a first encoder 14e, a first transmitter 14f, a second encoder 14g, and a second transmitter 14h. Furthermore, the remote screen controller 14 has a calculating unit 14j, a change attempt unit 14k, and a compression format selecting unit 14m.

The operation information obtaining unit 14a is a processor for obtaining operation information from the client terminal 20. Right or left clicks, double clicks or dragging by the mouse and the amount of movement of the mouse cursor obtained through a moving operation of the mouse are examples of the operation information. Furthermore, the amount of rotation of a mouse wheel, the type of a pushed key of the keyboard, and the like are also examples of the operation information.

The screen generator 14b is a processor for generating a screen image to be displayed on a display unit 22 of the client terminal 20. For example, the screen generator 14b starts the following process every time an update interval of the desktop screen, for example, 33 milliseconds (msec) elapses. Namely, the screen generator 14b compares the desktop screen displayed on the client terminal 20 at the previous frame generation time with the desktop screen written on the frame buffer 13 at the present frame generation time. The screen generator 14b joins and combines pixels at a changed portion of the previous frame and shapes the changed portion in a rectangular shape to generate an image of an update rectangle, and the screen generator 14b then generates a packet for transmission of the update rectangle.

The change frequency determining unit 14c is a processor for determining the inter-frame change frequency of every divided area of the desktop screen. For example, the change frequency determining unit 14c accumulates an update rectangle generated by the screen generator 14b in a working internal memory (not depicted) over a predetermined period. At this point, the change frequency determining unit 14c accumulates attribute information capable of specifying the position and the size of the update rectangle, for example, the coordinates of the apex of the upper left corner of the update rectangle and the width and the height of the update rectangle. The period for which the update rectangle is accumulated correlates with the identification precision of the high-frequency change area, and erroneous detection of the high-frequency change area is reduced more when the period is longer. In this embodiment, it is assumed that the image of the update rectangle is accumulated over 33 msec, for example.

At this point, when a predetermined period has elapsed after the accumulation of the image of the update rectangle, the change frequency determining unit 14c determines the change frequency of the desktop screen with a map obtained by dividing the desktop screen to be displayed on the client terminal 20 in a mesh-like fashion.

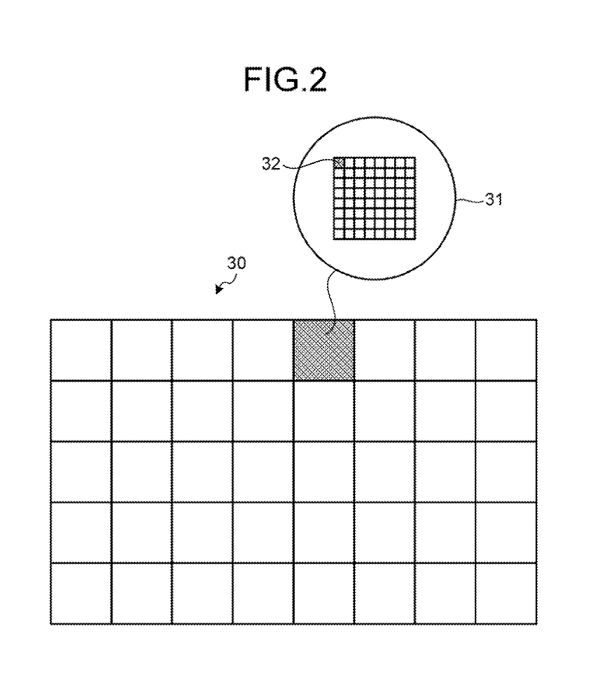

FIG. 2 is a diagram depicting the outline of division of the desktop screen. Reference numeral 30 in FIG. 2 represents a change frequency determining map. Reference numeral 31 in FIG. 2 represents a mesh contained in the map 30. Reference numeral 32 in FIG. 2 represents one pixel contained in a pixel block forming the mesh 31. In the example depicted in FIG. 2, it is assumed that the change frequency determining unit 14c divides the map 30 into blocks so that each block of 8 pixels×8 pixels out of the pixels occupying the map 30 is set as one mesh. In this case, 64 pixels are contained one mesh.

Here, the change frequency determining unit 14c successively develops the image of the update rectangle on the map for determining the change frequency in accordance with the position and the size of the updated rectangle accumulated in the working internal memory. The change frequency determining unit 14c accumulates and adds the number of changes of the mesh at a portion overlapping with the update rectangle on the map every time the update rectangle is developed onto the map. At this point, when the update rectangle developed on the map is overlapped with the pixels contained in the mesh over a predetermined number of times, the change frequency determining unit 14c increments the number of changes of the mesh by 1. In this embodiment, a description will be given of a case in which, when the update rectangle is overlapped with at least one pixel contained in the mesh, the number of changes of the mesh is incremented.

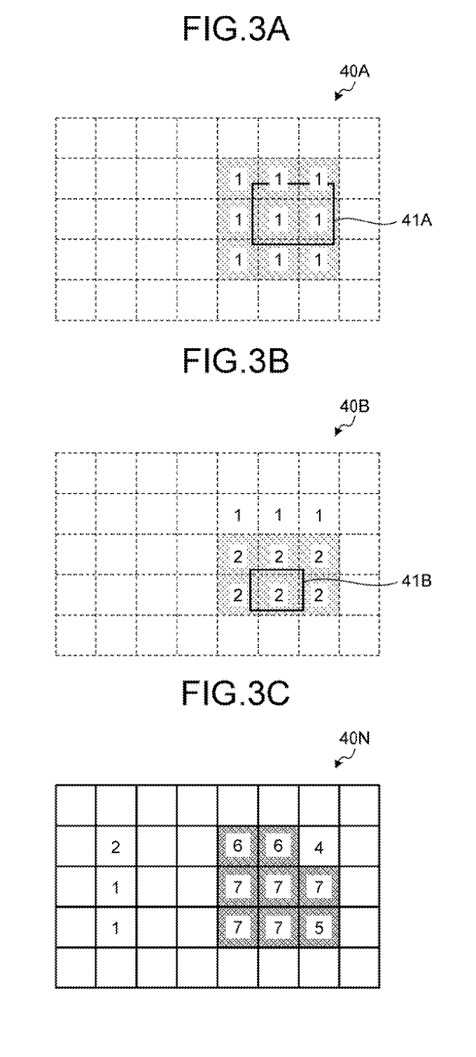

FIGS. 3A to 3C are diagrams depicting the outline of determination of the change frequency of the desktop screen. Reference numerals 40A, 40B, and 40N in FIGS. 3A to 3C represent the change frequency determining maps. Reference numerals 41A and 41B in FIGS. 3A and 3B, respectively, represent update rectangles. In this embodiment, numerals depicted in meshes of the map 40A represent the change frequencies of the meshes at the time point at which the update rectangle 41A is developed. Furthermore, numerals depicted in meshes of the map 40B represent the change frequencies of the meshes at the time point at which the update rectangle 41B is developed. Furthermore, numerals depicted in meshes of the map 40N represent the change frequencies of the meshes at the time point at which all update rectangles accumulated in the working internal memory are developed. In FIGS. 3A to 3C, it is assumed that the number of changes of a mesh in which no numeral is depicted is zero.

As depicted in FIG. 3A, when the update rectangle 41A is developed on the map 40A, the mesh of a hatched portion is overlapped with the update rectangle 41A. Therefore, the change frequency determining unit 14c increments the update frequency of the mesh of the hatched portions one by one. In this case, because the number of changes of each mesh is equal to zero, the number of changes of the hatched portion is incremented from 0 to 1. Furthermore, as depicted in FIG. 3B, when the update rectangle 41B is developed on the map 40B, the mesh of a hatched portion is overlapped with the update rectangle 41B. Therefore, the change frequency determining unit 14c increments the number of changes of the mesh of the hatched portions one by one. In this case, the change frequency of each mesh is equal to 1, and thus the number of changes of the hatched portion is incremented from 1 to 2. At the stage that all of the update rectangles are developed on the map as described above, the result of the map 40N depicted in FIG. 3C is obtained.

When the development of all the update rectangles accumulated in the working internal memory on the map is finished, the change frequency determining unit 14c obtains a mesh in which the number of changes, i.e., the change frequency for the predetermined period, exceeds a threshold value. This means that, in the example of FIG. 3C, the mesh of a hatched portion is obtained when the threshold value is set to “4”. As the threshold value is set to a higher value, a portion at which moving images are displayed on the desktop screen with high probability can be encoded by the second encoder 14g, described later. With respect to the “threshold value”, an end user may select a value which is stepwise set by a developer of the remote screen control application, or an end user may directly set a value.

The high-frequency change area identifying unit 14d is a processor for identifying, as a high-frequency change area, an area that is changed with high frequency on the desktop screen displayed on the client terminal 20.

Specifically, when meshes whose number of changes exceeds the threshold value are obtained by the change frequency determining unit 14c, the high-frequency change area identifying unit 14d corrects a mesh joint body obtained by joining adjacent meshes to a rectangle. For example, the high-frequency change area identifying unit 14d derives an interpolation area to be interpolated in the mesh joint body and then the interpolation area is added to the joint body, whereby the mesh joint body is corrected to a rectangle. An algorithm for deriving an area with which the joint body of meshes can be shaped to a rectangle by the minimum interpolation is applied to derive the interpolation area.

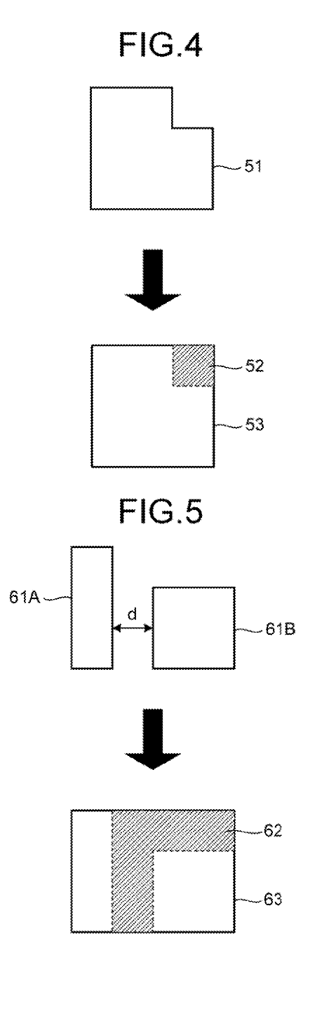

FIG. 4 is a diagram depicting the outline of correction of the mesh joint body. Reference numeral 51 in FIG. 4 represents a mesh joint body before correction, reference numeral 52 in FIG. 4 represents an interpolation area, and reference numeral 53 in FIG. 4 represents a rectangle after the correction. As depicted in FIG. 4, by adding the interpolation area 52 to the mesh joint body 51, the high-frequency change area identifying unit 14d corrects the mesh joint body 51 such that the mesh joint body 51 becomes the rectangle 53. At this stage, the synthesis of a rectangle, described later, has not been completed, and the rectangle 53 has not yet been settled as the high-frequency change area. Therefore, the rectangle after the correction is sometimes referred to as a “candidate of the high-frequency change area”.

When multiple candidates of the high-frequency change area are present, the high-frequency change area identifying unit 14d synthesizes a rectangle containing multiple candidates of the high-frequency change area in which the distance between the candidates is equal to or less than a predetermined value. The distance between the candidates mentioned here represents the shortest distance between the rectangles after correction. For example, the high-frequency change area identifying unit 14d derives an interpolation area to be filled among the respective candidates when the candidates of the high-frequency change area are combined with one another and then adds the interpolation area to the candidates of the high-frequency change area, thereby synthesizing the rectangle containing the candidates of the high-frequency change area. An algorithm for deriving an area in which the candidates of the high-frequency change area are shaped into a combination body by the minimum interpolation is applied to derive the interpolation area.

FIG. 5 is a diagram depicting the outline of combination of candidates of a high-frequency change area. Reference numerals 61A and 61B in FIG. 5 represent candidates of the high-frequency change area, reference numeral 62 in FIG. 5 represents an interpolation area, and reference numeral 63 in FIG. 5 represents a combination body of the candidate 61A of the high-frequency change area and the candidate 61B of the high-frequency change area. As depicted in FIG. 5, the high-frequency change area identifying unit 14d adds the interpolation area 62 to the candidate 61A of the high-frequency change area and to the candidate 61B of the high-frequency change area, the distance between which is equal to or less than a distance d, thereby synthesizing the combination body 63 containing the candidate 61A of the high-frequency change area and the candidate 61B of the high-frequency change area. The high-frequency change area identifying unit 14d identifies the thus-obtained combination body as the high-frequency change area.

When identifying the high-frequency change area as described above, the high-frequency change area identifying unit 14d transmits, to the client terminal 20, attribute information with which the position and the size of the high-frequency change area can be specified, whereby the portion corresponding to the high-frequency change area in the bit map image of the desktop screen displayed on the client terminal 20 is displayed as a blank. Thereafter, the high-frequency change area identifying unit 14d clears the number of changes of the meshes mapped in the working internal memory. The high-frequency change area identifying unit 14d registers the attribute information on the high-frequency change area in the working internal memory.

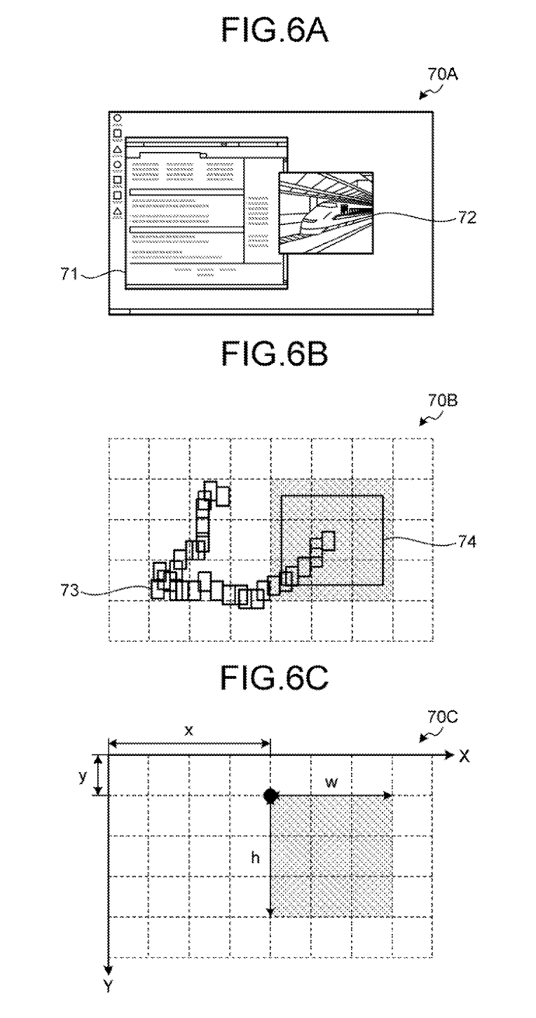

FIGS. 6A to 6C are diagrams depicting the outline of notification of the attribute information on the high-frequency change area. Reference numeral 70A in FIG. 6A represents an example of the desktop screen drawn on the frame buffer 13, and reference numerals 70B and 70C in FIGS. 6B to 6C represent change frequency determining maps. Reference numeral 71 in FIG. 6A represents a browser screen (window), reference numeral 72 in FIG. 6A represents a moving image reproducing screen, reference numeral 73 in FIG. 6B represents a movement locus of the mouse, and reference numeral 74 in FIG. 6B represents a moving image reproducing area using an application.

As depicted in FIG. 6A, the desktop screen 70A contains the browser screen 71 and the moving image reproducing screen 72. When a time-dependent variation is pursued from the desktop screen 70A, no update rectangle is detected on the browser screen 71 as a still image and update rectangles associated with the movement locus 73 of the mouse and the moving image reproducing area 74 are detected, as depicted in FIG. 6B. In this case, it is assumed that a mesh in which the number of changes exceeds the threshold value in the moving image reproducing area 74, i.e., a hatched portion in FIG. 6B, is identified by the high-frequency change area identifying unit 14d. In this case, the high-frequency change area identifying unit 14d transmits, to the client terminal 20, the coordinates (x, y) of the apex at the upper left corner of the high-frequency change area of the hatched portion in FIG. 6C and the width w and the height h of the high-frequency change area as the attribute information on the high-frequency change area.

In this embodiment, the coordinates of the apex at the upper left corner are adopted as a point for specifying the position of the high-frequency change area, but another apex may be adopted. Any point other than the apex, for example, the center of gravity, may be adopted as long as it can specify the position of the high-frequency change area. Furthermore, the upper left corner on the screen is set as the origin of the coordinate axes X and Y, but any point within the screen or outside of the screen may also be adopted as the origin.

When the high-frequency change area is detected at a part of the desktop screen as described above, animation for moving images of the high-frequency change area on the desktop screen is started. In this case, the high-frequency change area identifying unit 14d inputs a bit map image in a high-frequency change area out of the bit map image drawn on the frame buffer 13 to the second encoder 14g, which will be described later. Furthermore, after the high-frequency change area has been detected, from the viewpoint of suppressing the state in which the animation is frequently changed between ON and OFF, the animation in the high-frequency change area is continued for a predetermined period e.g., for one second, until a high-frequency change area is not detected. In this case, even when an area is not identified as a high-frequency change area, the animation is executed on the previously identified high-frequency change area. On the other hand, with respect to an update rectangle that is not contained in the high-frequency change area, it may be compressed in a still image compression format as in the case of the stage before the animation for moving images is started. That is, the image of the update rectangle that is not contained in the high-frequency change area out of the bit map image drawn on the frame buffer 13 is input to the first encoder 14e, described later, via the calculating unit 14j, described later.

The first encoder 14e is a processor for encoding an image of the update rectangle input by the screen generator 14b by using a compression format of a still image specified by the change attempt unit 14k or the compression format selecting unit 14m, which will be described later, from among multiple compression formats of a still image

In the first embodiment, a case has been described in which, as a compression format of a still image described above, JPEG or Portable Network Graphics (PNG) is selectively used by the first encoder 14e. The reason for optionally using JPEG or PNG is to compensate for weakness of JPEG and PNG by compressing an image unsuitable for JPEG using PNG and by compressing an image unsuitable for PNG using JPEG.

For example, when designing/drawing software, such as Computer-Aided Design (CAD), is executed by the application execution controller 11b, an object, such as a product or a part constituting the product, is rendered by using a wire frame or shading. When the rendering is performed using a wire frame, an object is drawn in a linear manner. On the other hand, when the rendering is performed using shading, an object is drawn by a shading method using, for example, a polygon. In the following description, an object drawn using a wire frame is sometimes referred to as a “wire frame model” and an object drawn using shading is sometimes referred to as a “shading model”.

Accordingly, the number of colors in a wire frame model is sometimes less than that in a shading model. Therefore, the wire frame model is unsuitable for JPEG in which the compression ratio becomes high by removing high-frequency components from among the frequency components of the colors constituting an image. On the other hand, with the shading model, shading is represented by using a polygon or the like and thus the number of colors constituting an image is large. Accordingly, with the shading model, the compression effect obtained when an image is compressed using PNG is limited when compared with a case in which an image is compressed using JPEG; therefore, the shading model may be unsuitable for PNG.

Accordingly, a compression format of a still image is selected by the compression format selecting unit 14m, which will be described later, such that an image unsuitable for JPEG is compressed using PNG and an image unsuitable for PNG is compressed using JPEG. In this case, a case is described as an example in which the wire frame model and the shading model are used. However, in a case of using a model other than these, this is also applied to a case of displaying a background image in which a natural image is displayed or displaying both a window and a window generated by using document creating software or by using spreadsheet software.

The first transmitter 14f is a processor for transmitting the encoded data of the update rectangle encoded by the first encoder 14e to the client terminal 20. When the update rectangle is transmitted, for example, an RFB protocol in the VNC is used for a communication protocol.

The second encoder 14g is a processor for encoding an image input from the high-frequency change area identifying unit 14d in a moving image compression format. For example, the second encoder 14g compresses an image in a high-frequency change area or in a change area using MPEG, thereby encoding the image to encoded data on a moving image. In this example, MPEG is exemplified as the moving image compression format; however, another format, such as Motion-JPEG, may also be applied.

The second transmitter 14h is a processor for transmitting the encoded data of the moving image encoded by the second encoder 14g to the client terminal 20. For example, the Real-time Transport Protocol (RTP) can be used for a communication protocol used when an encoded image in the high-frequency change area.

The calculating unit 14j is a processor for calculating various parameters, such as the area of an update rectangle or the compression ratio of a still image, that are used for determining whether an attempt to change the compression format of a still image is to be made.

For example, the calculating unit 14j calculates the area of an update rectangle by counting the number of pixels contained in an image of the update rectangle generated by the screen generator 14b. Then, the calculating unit 14j stores the area of the update rectangle calculated as described above in a working internal memory (not depicted) by associating the identification information on the update rectangle, the identification information on the frame in which the update rectangle is generated, and the position of the update rectangle. The area of the update rectangle is calculated for each update rectangle that is input by the screen generator 14b.

For another example, the calculating unit 14j calculates the compression ratio of encoded data on a still image. For example, the calculating unit 14j calculates the compression ratio of the current frame by dividing the amount of encoded data on a still image encoded by the first encoder 14e by the amount of data of an image of an update rectangle created by the screen generator 14b. Furthermore, the calculating unit 14j calculates the average value of the compression ratios of the frames other than the current frame by averaging the compression ratio of the current frame and the compression ratios of a predetermined number of frames, e.g., five frames previously calculated, that have been calculated before the compression ratio of the current frame is calculated. Furthermore, if a moving image in a high-frequency change area that is transmitted to the client terminal 20 when the animation is being performed is overwritten with a still image after the animation, the calculating unit 14j calculates the compression ratio of an image in an overwrite area that was a high-frequency change area when the animation was being performed. In this example, a description has been given of a case in which the compression ratio is calculated by dividing the amount of the data of the compressed image by the amount of the data of the image that has not been compressed; however, a method for calculating a compression ratio is not limited thereto. For example, the calculating unit 14j may also calculate a compression ratio by dividing the difference between the amount of data of pre-compression image and post-compression image by the amount of data of pre-compression image.

The change attempt unit 14k is a processor for attempting a change in a compression format used by the first encoder 14e when the second encoder 14g ends the compression of a moving image.

For example, first, the change attempt unit 14k determines whether a value, which is obtained by dividing the area of the update rectangle calculated by the calculating unit 14j by the area of an update rectangle that overlaps with the update rectangle in the previous frame stored in the working internal memory, is equal to or greater than a predetermined threshold. Specifically, the change attempt unit 14k determines whether the ratio of the area of the update rectangle in the current frame to the area of the update rectangle in the previous frame is equal to or greater than a predetermined threshold, e.g., 1:10. If there are multiple update rectangles overlapping with the position of the update rectangle in the current frame, the update rectangle having the maximum area is used for the comparison.

For the threshold value described above, a value with which the occurrence of a scene change can be detected, such as the displaying or the deletion of a window, the displaying of a new object, or a change in a rendering technique, is used instead of a change in part of a window on a desktop screen or a change in part of an object in a window. An example of a scene change includes a case in which an object is changed from a wire frame model to a shading model or vice versa on a CAD window displayed by CAD system. Even when a scene change has occurred, because update areas rarely match between frames, the update rectangle in the current frame is preferably contracted to about 10% of the size of the update rectangle in the previous frame.

Then, if the change attempt unit 14k determines that the ratio of the update rectangle in the previous frame to the update rectangle in the current frame is equal to or greater than the threshold, the change attempt unit 14k further determines whether the compression ratio of the current frame increases by a predetermined threshold value or more compared with the average value of the compression ratios of the frames. Accordingly, the change attempt unit 14k can determine whether the compression ratio of the current frame becomes worse than the average value of the compression ratios of the previous frames. A value for which it is worth attempting a change in a compression format of a still image is used for the threshold value described above. Specifically, if there is little difference between the compression ratio of the current frame and the average value of the compression ratios of the previous frames, there may be a case in which a sample that has worsened by coincidence is possibly changed. Accordingly, the threshold value is preferably set such that the compression ratio of the current frame is twice the average value of the compression ratios of the previous frames.

At this point, when the compression ratio of the current frame increases by the threshold value or more, the change attempt unit 14k sets a change attempt flag stored in the working internal memory (not depicted) to ON. The “change attempt flag” mentioned here is a flag indicating whether to attempt a change in a compression format of an overwrite image overwritten in a high-frequency change area after the animation. For example, if a change attempt flag is ON, an attempt is made to change the compression format of an overwrite image, whereas, if the change attempt flag is OFF, an attempt is not made to change the compression format of an overwrite. The change attempt unit 14k sets a change attempt flag to OFF when an attempt is made to encode the overwrite image, which is overwritten in an area corresponding to the high-frequency change area obtained when animation ends, by using a compression format that is different from that selected by the compression format selecting unit 14m.

The compression format selecting unit 14m is a processor for selecting a compression format of a still image used by the first encoder 14e based on the result of comparing the compression ratio of compressed data on still images in update areas obtained before and after the attempt to change the compression format made by the change attempt unit 14k.

For example, the compression format selecting unit 14m determines whether the compression ratio of the overwrite image, for which an attempt to change a compression format is made, decreases by a predetermined threshold value or more compared with the average value of the compression ratios stored in the working internal memory, i.e., the average value of the compression ratios that have been calculated before the animation. By doing so, the compression format selecting unit 14m can determine whether the compression ratio of the overwrite image, for which an attempt to change a compression format is made, is improved when compared with the average value of the compression ratios that have been calculated before the animation. At this point, if the compression ratio of the overwrite image decreases by the threshold or more, it can be determined that it is preferable to change the compression format of the still. In such a case, the compression format selecting unit 14m changes the compression format of the still image that is used by the first encoder 14e to the compression format that the change attempt unit 14k attempts to change. Furthermore, if the compression ratio of the overwrite image is not reduced by an amount equal to or greater than the threshold, it can be determined that the compression format of the still image is not changed. In such a case, the compression format of the still image used by the first encoder 14e is not changed.

Specific Example

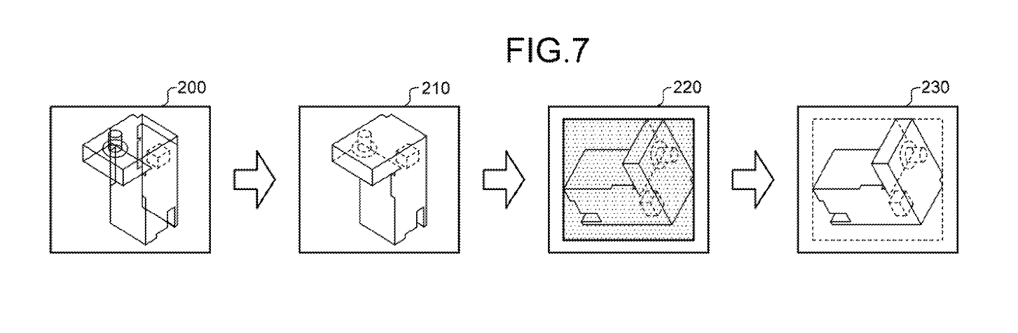

In the following, a method for selecting a compression format of a still image will be described with reference to FIG. 7. FIG. 7 is a diagram depicting a method for selecting a compression format of a still image. In the example depicted in FIG. 7, a description will be given of a case in which CAD is executed in the server device 10 in response to the operation information from the client terminal 20. in FIG., reference numerals 200 and 210 represent 7 update rectangle images, reference numeral 220 represents an image in a high-frequency change area, and reference numeral 230 represents an overwrite image.

For example, when the operation of reading an object is executed in a CAD window, an object subjected to rendering using a wire frame is displayed. In such a case, because an object in a wire frame model is displayed after a state in which an object is not present in the CAD window, the update rectangle 200 containing the object in the wire frame model is generated.

Then, when the operation is performed of changing the display of the object in the CAD window from the wire frame model to the shading model, the update rectangle 210 containing an object in a shading model is generated. At this point, if PNG is selected as a compression format of the still image, because the number of colors constituting the CAD window increases in accordance with the scene change from the wire frame model to the shading model, the compression ratio becomes worse. For example, when the compression ratio of the update rectangle 210 becomes worse by a factor of two compared with the compression ratio of the update rectangle 200, the change attempt flag is set to ON.

Subsequently, when the operation of rotating an object in the CAD window is accepted, the change frequency increases in accordance with the rotation of the object and an area containing the entire object is identified as a high-frequency change area. In this way, the image 220 in the high-frequency change area containing the object in the shading model is displayed as a moving image.

Then, if no operation is performed when the CAD window is displayed, the animation ends and the overwrite image that is overwritten in an area that has been the high-frequency change area during the animation is transmitted to the client terminal 20. At this point, because the change attempt flag is set to ON, the overwrite image 230 that is not compressed using PNG but using JPEG is displayed after it is transmitted to the client terminal 20. In this case, the compression ratio of the overwrite image 230 compressed using JPEG is improved by a factor of two compared with the average value of the compression ratio of the update rectangle 210 that was compressed using PNG. Accordingly, the compression format of the subsequent still image is changed to JPEG.

As described above, with the server device 10 according to the embodiment, when an object is changed to that in a shading model unsuitable for PNG, the server device 10 can change the compression format to JPEG, which exhibits the performance of compressing an image containing a lot of colors. Because an attempt is made to change the compression format after the animation ends, the attempt to change the compression format takes place when the change frequency of the desktop screen decreases. Consequently, the processing load on the server device 10 can be reduced when an attempt to change the compression format is made.

Various kinds of integrated circuits and electronic circuits may be adopted for the OS execution controller 11a, the application execution controller 11b, the graphic driver 12 and the remote screen controller 14. Some of the functional units contained in the remote screen controller 14 may be implemented by other integrated circuits or electronic circuits. For example, an application specific integrated circuit (ASIC) or a field programmable gate array (FPGA) may be adopted as the integrated circuits. Furthermore, a central processor unit (CPU), a micro processor unit (MPU), or the like may be adopted as the electronic circuit.

Construction of Client Terminal

Next, the functional construction of the client terminal according to this embodiment will be described. As depicted in FIG. 1, the client terminal 20 has an input unit 21, the display unit 22, and a remote screen controller 23 on the client side. In the example of FIG. 1, it is assumed that the various kinds of functional units with which an existing computer is provided, for example, functions, such as an audio output unit and the like, are provided in addition to the functional units depicted in FIG. 1.

The input unit 21 is an input device for accepting various kinds of information, for example, an instruction input to the remote screen controller 23 on the client side, which will be described later. For example, a keyboard or a mouse may be used. The display unit 22, described later, implements a pointing device function in cooperation with the mouse.

The display unit 22 is a display device for displaying various kinds of information, such as a desktop screen and the like, transmitted from the server device 10. For example, a monitor, a display, or a touch panel may be used for the display unit 22.

The remote screen controller 23 is a processor for receiving a remote screen control service supplied from the server device 10 through the remote screen control application on the client side. As depicted in FIG. 1, the remote screen controller 23 has an operation information notifying unit 23a, a first receiver 23b, a first decoder 23c, and a first display controller 23d. Furthermore, the remote screen controller 23 has a second receiver 23e, a second decoder 23f, and a second display controller 23g.

The operation information notifying unit 23a is a processor for notifying the server device 10 of operation information obtained from the input unit 21. For example, the operation information notifying unit 23a notifies the server device 10 of right or left clicks, double clicks and dragging by the mouse, the movement amount of the mouse cursor obtained through the moving operation of the mouse, and the like as operation information. As another example, the operation information notifying unit 23a notifies the server device 10 of the rotational amount of the mouse wheel, the type of a pushed key of the keyboard, and the like as the operation information.

The first receiver 23b is a processor for receiving the encoded data of the update rectangle transmitted by the first transmitter 14f in the server device 10. The first receiver 23b also receives the attribute information on the high-frequency change area transmitted by the high-frequency change area identifying unit 14d in the server device 10.

The first decoder 23c is a processor for decoding the encoded data of the update rectangle received by the first receiver 23b. A decoder having a decoding system that is suitable for the encoding system installed in the server device 10 is mounted in the first decoder 23c.

The first display controller 23d is a processor for making the display unit 22 display the image of the update rectangle decoded by the first decoder 23c. For example, the first display controller 23d makes the display unit 22 display the bit map image of the update rectangle on a screen area of the display unit 22 that corresponds to the position and the size contained in the attribute information on the update rectangle received by the first receiver 23b. Furthermore, when the attribute information on the high-frequency change area is received by the first receiver 23b, the first display controller 23d executes the following process. Namely, the first display controller 23d sets the screen area of the display unit 22 associated with the position and the size of the high-frequency change area contained in the attribute information on the high-frequency change area as a blank area that is out-of-target with respect to the displaying of the bit map image.

The second receiver 23e is a processor for receiving the encoded data on the moving images transmitted by the second transmitter 14h in the server device 10. The second receiver 23e also receives the attribute information on the high-frequency change area transmitted by the high-frequency change area identifying unit 14d in the server device 10.

The second decoder 23f is a processor for decoding the encoded data on the moving images received by the second receiver 23e. A decoder having a decoding system suitable for the encoding format installed in the server device 10 is mounted in the second decoder 23f.

The second display controller 23g is a processor for making the display unit 22 display the high-frequency change area decoded by the second decoder 23f based on the attribute information on the high-frequency change area that is received by the second receiver 23e. For example, the second display controller 23g makes the display unit 22 display the image of the moving image of the high-frequency change area on the screen area of the display unit 22 associated with the position and the size of the high-frequency change area contained in the attribute information on the high-frequency change area.

Various kinds of integrated circuits and electronic circuits may be adopted for the remote screen controller 23 on the client side. Furthermore, some of the functional units contained in the remote screen controller 23 may be implemented by other integrated circuits or electronic circuits. For example, an ASIC or an FPGA may be adopted as an integrated circuit, and a CPU, an MPU, or the like may be adopted as an electronic circuit.

Flow of Process

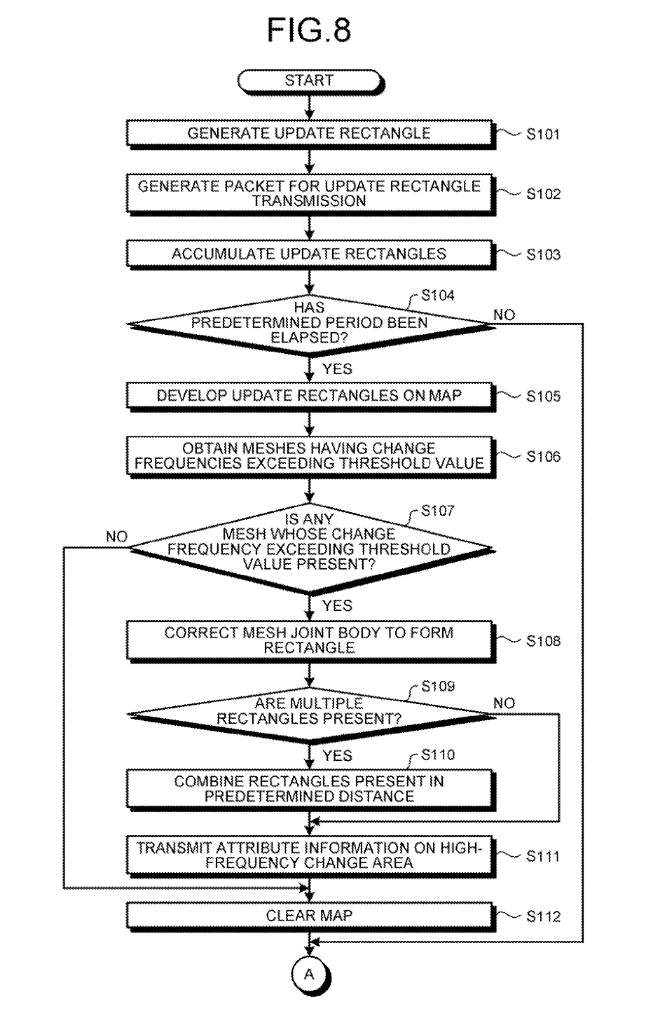

Next, the flow of the process performed by the server device 10 according to the first embodiment will be described. FIGS. 8 to 10 are flowcharts depicting the flow of the image transmission process according to the first embodiment. The image transmission process is a process executed by the server device 10 and starts when bits map data is drawn on the frame buffer 13.

As depicted in FIG. 8, the screen generator 14b joins pixels at a portion changed from a previous frame and then generates an image of an update rectangle shaped into a rectangle (Step S101). Then, the screen generator 14b generates a packet for update rectangle transmission from a previously generated update rectangle image (Step S102).

Subsequently, the change frequency determining unit 14c accumulates the update rectangles generated by the screen generator 14b in to a working internal memory (not depicted) (Step S103). At this point, when a predetermined period has not elapsed from the start of the accumulation of update rectangle (No at Step S104), subsequent processes concerning identification of the high-frequency change area is skipped, and the process moves to Step S113, which will be described later.

On the other hand, when the predetermined period has elapsed from the start of the accumulation of the update rectangle (Yes at Step S104), the change frequency determining unit 14c executes the following process. Namely, the change frequency determining unit 14c successively develops the images of the update rectangles on the change frequency determining map according to the positions and the sizes of the update rectangles accumulated in the working internal memory (Step S105). Then, the change frequency determining unit 14c obtains meshes having change frequencies exceeding the threshold value out of the meshes contained in the change frequency determining map (Step S106).

Thereafter, the high-frequency change area identifying unit 14d the server device 10 determines whether any mesh whose change frequency exceeds the threshold value is obtained (Step S107). At this point, when no mesh whose change frequency exceeds the threshold value is present (No at Step S107), no high-frequency change area is present on the desktop screen. Therefore, the subsequent process concerning the identification of the high-frequency change area is skipped, and the process moves to Step S112.

On the other hand, when a mesh whose change area exceeds the threshold value is present (Yes at Step S107), the high-frequency change area identifying unit 14d corrects the mesh joint body obtained by joining adjacent meshes to form a rectangle (Step S108).

When multiple corrected rectangles, i.e., multiple high-frequency change area candidates are present (Yes at Step S109), the high-frequency change area identifying unit 14d executes the following process. Namely, the high-frequency change area identifying unit 14d combines corrected rectangles so as to synthesize a rectangle containing multiple high-frequency change area candidates that are spaced from one another at a predetermined distance value or less (Step S110). When multiple high-frequency change areas are not present (No at Step S109), the synthesis of the rectangle is not performed, and the process moves to Step S111.

Subsequently, the high-frequency change area identifying unit 14d transmits to the client terminal 20 the attribute information from which the position and the size of the high-frequency change area can be specified (Step S111). Then, the high-frequency change area identifying unit 14d clears the number of changes of the meshes mapped in the working internal memory (Step S112).

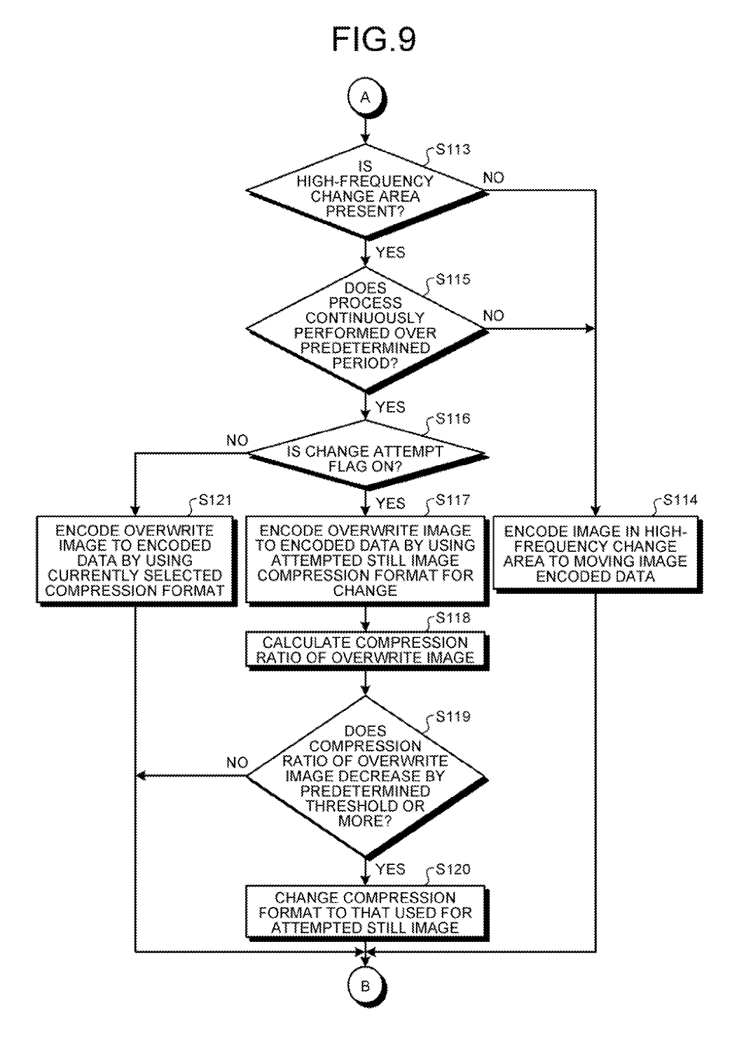

Thereafter, as depicted in FIG. 9, if a high-frequency change area is detected (No at Step S113), the second encoder 14g encodes the image in the high-frequency change area to the moving image encoded data (Step S114).

Furthermore, although a high-frequency change area is not detected and if the detection of a high-frequency change area is continuously performed over a predetermined period (Yes at Step S113 and No at Step S115), the second encoder 14g also encodes the image in the high-frequency change area to the moving image encoded data (Step S114).

On the other hand, if a high-frequency change area is not continuously detected over a predetermined period (Yes at Step S113 and Yes at Step S115), the compression format selecting unit 14m refers to the change attempt flag stored in the working internal memory (Step S116).

At this point, if the change attempt flag is ON (Yes at Step S116), the compression format selecting unit 14m attempts to change the compression format to another compression format other than that used for the currently selected still image and encodes an overwrite image into the still image encoded data (Step S117). Subsequently, the calculating unit 14j calculates the compression ratio of the overwrite image (Step S118).

Then, the compression format selecting unit 14m determines whether the compression ratio of the overwrite image, for which an attempt to change the compression format is made, decreases by a predetermined threshold value compared with the average value of the compression ratios calculated before the animation (Step S119).

If the compression ratio of the overwrite image decreases by the threshold value or more (Yes at Step S119), it is determined that it is preferable to change the compression format of the still image. Accordingly, the compression format selecting unit 14m changes the compression format of the still image used by the first encoder 14e to the compression format of the still image that has been changed by the change attempt unit 14k (Step S120). On the other hand, if the compression ratio of the overwrite image does not decrease by the threshold value or more (No at Step S119), it is determined that the compression format of the still image does not need to be changed. In such a case, the compression format of the still image used by the first encoder 14e is not changed and the process moves to Step S122.

Furthermore, if the change attempt flag is OFF (No at Step S116), the compression format selecting unit 14m encodes the overwrite image to the still image encoded data by using the currently selected compression format (Step S121).

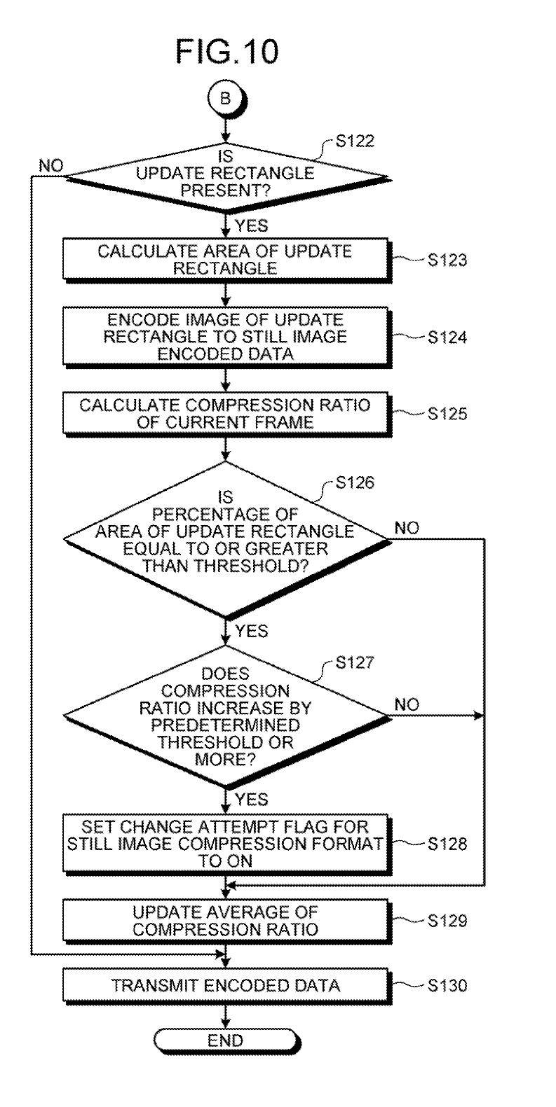

Thereafter, as depicted in FIG. 10, if an update rectangle is present (Yes at Step S122), the calculating unit 14j calculates an area of the update rectangle by counting the number of pixels in the image of the update rectangle (Step S123). Furthermore, if an update rectangle is not present (No at Step S122), the subsequent processes performed at Steps S123 to S129 are skipped and the process moves to Step S130.

Subsequently, the first encoder 14e encodes the image of the update rectangle to the still image encoded data (Step S124). Then, the calculating unit 14j calculates the compression ratio of the current frame by dividing the amount of the data of the still image encoded data that is encoded by the first encoder 14e by the amount of the data of the image of the update rectangle generated by the screen generator 14b (Step S125).

Then, the change attempt unit 14k determines whether the ratio of the area of the update rectangle in the current frame to the area of the update rectangle in the previous frame is equal to or greater than the threshold value (Step S126). If the ratio of the area of the update rectangle in the current frame is equal to or greater than the threshold value (Yes at Step S126), the change attempt unit 14k further determines whether the compression ratio of the current frame increases by a predetermined threshold value or more compared with the average value of the compression ratios of the previous frames (Step S127).

If the ratio of the area of the update rectangle in the current frame is equal to or greater than the threshold value and if the compression ratio of the current frame increases by the threshold value or more (Yes at Step S126 and Yes at Step S127), the change attempt unit 14k executes the following process (Step S128). Namely, the change attempt unit 14k sets the change attempt flag stored in a working internal memory (not depicted) to ON.

Furthermore, the ratio of the area of the update rectangle in the current frame is less than the threshold value or if the compression ratio of the current frame does not increase the threshold value or more (No at Step S126 or No at Step S127), the change attempt flag is not set to ON and the process moves to Step S129.

Then, the calculating unit 14j updates the average value of the compression ratio of the previous frames by averaging the compression ratio of the current frame and the compression ratio of the predetermined number of frames, e.g., the previous five frames, that have been calculated before the compression ratio of the current frame is calculated (Step S129).

Then, the first transmitter 14f and the second transmitter 14h transmit the still image and/or the moving image encoded data to the client terminal 20 (Step S130) and end the process.

Advantage of the First Embodiment

As described above, with the server device 10 according to the first embodiment, when changing the transmission of the desktop screen from the moving image to the still image, the server device 10 selects a compression format based on the quality of the compression ratio after attempting to compress the screen by using another compression format of the still image. Accordingly, because the server device 10 according to the first embodiment appropriately changes multiple compression formats, the compression process can be executed on the still image while weaknesses of multiple compression formats of a still image compensate for each other. Furthermore, with the server device 10 according to the first embodiment, because an attempt is made to change the compression format after the animation ends, an attempt to change the compression format is made when the change frequency of the desktop screen is reduced. Therefore, the server device 10 according to the first embodiment can improve the reduction efficiency of the amount of data transmission while reducing the processing load.

### [b] Second Embodiment

In the above explanation, a description has been given of the embodiment according to the present invention; however, the embodiment is not limited thereto and can be implemented with various kinds of embodiments other than the embodiment described above. Therefore, another embodiment included in the present invention will be described below.

Three or More Compression Formats

In the first embodiment, a description has been given of a case in which either one of PNG or JPEG is selectively used; however, the embodiment may also be used for a case in which a still image is compressed by changing three or more compression formats including the other compression formats of the still image. For example, a compression format of a still image, such as Hextile, other than PNG or JPEG can be used for the disclosed device. When selecting a compression format from among three or more compression formats with which a change is attempted, the attempts to change compression formats are made in the order they are previously set. Alternatively, it may also possible to select the compression format having the highest compression ratio after compressing an overwrite image by using all of the compression formats.

The Number of Colors

In the first embodiment described above, an attempt to change a compression format is made when the area of the update rectangle or the compression ratio of the still image satisfies a predetermined condition. However, it is also possible to add a condition related to the number of colors constituting a still image. For example, the disclosed device counts the number of colors contained in an image in an update area. Then, if the currently selected compression format is PNG and if the number of colors of the update rectangle is equal to or greater than a predetermined threshold, the disclosed device attempts to change the compression format to JPEG. Furthermore, if the currently selected compression format is JPEG and if the number of colors of the update rectangle is less than the predetermined threshold, the disclosed device attempts to change the compression format to PNG. By doing so, it is possible to attempt a change in compression formats so that the compression formats compensate, for each other's weaknesses in the properties they exhibit when an image has a large number of colors and the properties they exhibit when an image has a small number of colors.

Change Area of the Compression Format

In the first embodiment described above, a description has been given of a case in which the same compression format is used for a still image on a desktop screen; however, it is also possible to use different compression formats of a still image in multiple areas on the desktop screen. For example, it is assumed that a desktop screen displays multiple windows including a CAD window containing an object subjected to rendering using a wire frame and a CAD window containing an object subjected to the rendering using shading. In such a case, the disclosed device may also be able to execute the determination performed by the change attempt unit 14k at Steps S126 to S127 for each area of a window displayed on the desktop screen and sets, for each area, a change attempt flag in accordance with the determination result. Accordingly, the disclosed device can execute a still image compression by using PNG on an update rectangle in an area corresponding to the CAD window containing a wire frame object on the desktop screen. Furthermore, the disclosed device can also execute still image compression by using JPEG on an update rectangle in an area corresponding to the CAD window containing a shaded object on the desktop screen.

Extension of Map Clearing

For example, in the first embodiment described above, a description has been given of a case in which the high-frequency change area identifying unit 14d clears the change frequency determining map in conformity with (in synchronization with) the update rectangle accumulating period. However, the timing at which the change frequency determining map is cleared is not limited to thereto.

For example, even after the change frequency does not exceed the threshold value in an area identified as a high-frequency change area, the high-frequency change area identifying unit 14d can continuously identify the area as a high-frequency change area over a predetermined period.

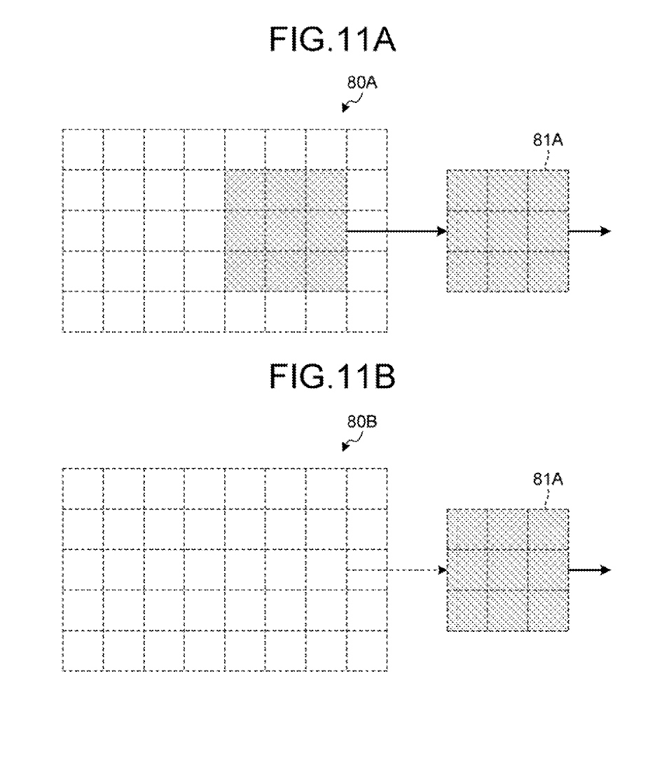

FIGS. 11A and 11B are diagrams each depicting the outline of an extension of map clearing. FIG. 11A depicts a change frequency determining map 80A at the time point when a high-frequency change area is first identified and depicts an identification result 81A of the high-frequency change area at that time point. Furthermore, FIG. 11B depicts a change frequency determining map 80B at a specific time point within a predetermined period from the time when the high-frequency change area is first identified and depicts the identification result 81A of the high-frequency change area at that time point.

As depicted in FIG. 11A, when a mesh joint body having the number of changes exceeding a threshold value is obtained on the map 80A and the identification result 81A of a high-frequency change area is obtained, the identification result 81A is taken over for a predetermined period even when no mesh joint body having the number of changes exceeding the threshold value is subsequently obtained. Specifically, as depicted in FIG. 11B, the identification result 81A of the high-frequency change area is taken over as long as the time period is within the predetermined period after the identification result 81A of the high-frequency change area is first identified even when no mesh joint body having the number of changes exceeding the threshold value on the map 80A is obtained. An end user may select as the “threshold value” a value that is set stepwise by the developer of the remote screen control application on the server side, or the end user may directly set the “threshold value.”

Accordingly, even when motion is intermittently stopped in an area where moving images are actually reproduced, the high-frequency change area is not intermittently identified, and thus frame drop of images can be prevented from intermittently occurring in the high-frequency change area. Furthermore, because the identification result of the high-frequency change area is taken over, the size of the high-frequency change area is stable. Therefore, the frequency at which parameters at the encoding time are initialized can be reduced, so the load imposed on the encoder can be reduced.

Suppression of Contraction of High-Frequency Change Area

For another example, the high-frequency change area identifying unit 14d executes the following process when an area identified as a high-frequency change area is more contractive than an area that was previously identified as the high-frequency change area. Namely, the high-frequency change area identifying unit 14d takes over the area previously-identified as the high-frequency change area as a present identification result when the degree of the contraction concerned is equal to or less than a predetermined threshold value.

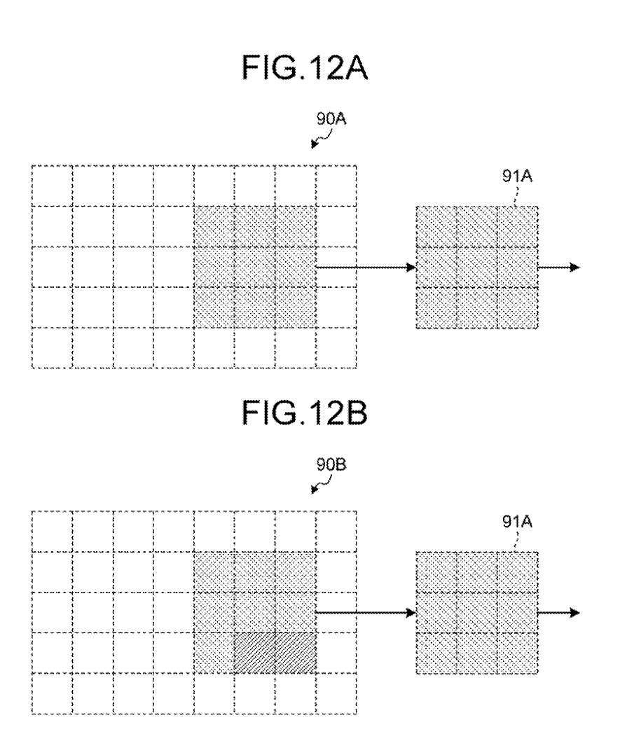

FIGS. 12A and 12B are diagrams depicting the outline of suppression of the contraction of the high-frequency change area. FIG. 12A depicts a change frequency area determining map 90A and an identification result 91A of a high-frequency change area at a time point T1. FIG. 12B depicts a change frequency area determining map 90B and the identification result 91A of a high-frequency change area at a time point T2. The time point T1 and the time point T2 are assumed to satisfy T1<T2.

As depicted in FIG. 12A, if a mesh joint body having the number of changes exceeding a threshold value is obtained on the map 90A and if the identification result 91A of a high-frequency change area is obtained, the high-frequency change area is not immediately contracted even when the mesh joint body having the number of changes exceeding the threshold value is contracted. Specifically, as depicted in FIG. 12B, even when the mesh joint body having a number of changes exceeding the threshold value is contracted at a hatched portion thereof, the identification result 91A of the high-frequency change area is taken over under the condition that the contraction area of the hatched portion is equal to or less than a predetermined threshold value, for example, a half.

Accordingly, even when a part of the motion is intermittent in an area where moving images are actually reproduced, the high-frequency change area is not intermittently identified. Consequently, frame drop of images can be prevented from intermittently occurring in the high-frequency change area. Furthermore, because the identification result of the high-frequency change area is taken over, the size of the high-frequency change area is stable. Therefore, the initialization frequency of the parameters in the encoding operation can be reduced, and thus the load imposed on the encoder can be reduced.

Overwrite Area

In the first embodiment, a description has been given of a case in which an area that has been a high-frequency change area during the animation is used as an overwrite area; however, the disclosed device is not limited thereto. For example, the disclosed device may also use the whole of the desktop screen as an overwrite area, or alternatively, it may also use only an area, in which an update rectangle is actually generated during the period from the start of the animation to the end of the animation, as an overwrite area.

Dispersion and Integration

The components of each unit illustrated in the drawings are only for conceptually illustrating the functions thereof and are not always physically configured as depicted in the drawings. In other words, the specific shape of a separate or integrated device is not limited to the drawings. Specifically, all or part of the device can be configured by functionally or physically separating or integrating any of the units depending on various loads or use conditions. For example, the image transmission process each executed by the first transmitter 14f and the second transmitter 14h of the server device 10 may also be integrally performed by one transmitter. Furthermore, the image receiving process each executed by the first receiver 23b and the second receiver 23e of the client terminal 20 may also be integrally performed by a single image receiver. Furthermore, the display control process each executed by the first display controller 23d and the second display controller 23g of the client terminal may also be performed by a single display controller.

Image Transmission Program

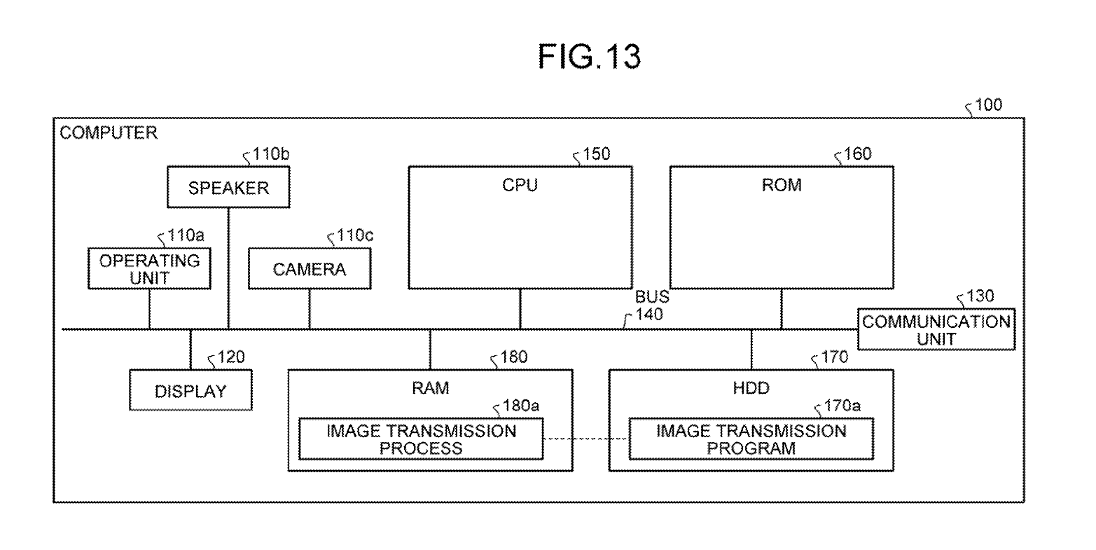

Various kinds of processes described in the embodiments described above may be implemented by executing programs written in advance for a computer such as a personal computer or a workstation. Therefore, in the following, an example of a computer that has the same functions as the above embodiments and executes an image transmission program will be described with reference to FIG. 13.

FIG. 13 is a diagram depicting an example of a computer for executing the image transmission program according to the first and second embodiments. As depicted in FIG. 13, a computer 100 has an operating unit 110a, a speaker 110b, a camera 110c, a display 120, and a communication unit 130. Furthermore, the computer 100 has a CPU 150, a ROM 160, an HDD 170, and a RAM 180. These devices 110 to 180 are connected to one another via a bus 140.

As depicted in FIG. 13, the HDD 170 stores therein, in advance an image transmission program 170a having the same function as that performed by the remote screen controller 14 on the server side described in the first embodiment. The image transmission program 170a may also be appropriately integrated or separated as in the case of the respective components of each of the remote screen controller 14 depicted in FIG. 1. Specifically, all the data stored in the HDD 170 does not always have to be stored in the HDD 170, and part of data for processes may be stored in the HDD 170.

The CPU 150 reads the image transmission program 170a from the HDD 170, and loads the read-out image transmission program 170a in the RAM 180. Accordingly, as depicted in FIG. 13, the image transmission program 170a functions as an image transmission process 180a. The image transmission process 180a arbitrarily loads various kinds of data read from the HDD 170 into corresponding areas allocated to the respective data in the RAM 180 and executes various kinds of processes based on the loaded data. The image transmission process 180a contains the processes executed by the remote screen controller 14 depicted in FIG. 1, for example, the processes depicted in FIGS. 8 to 10. Furthermore, for processors virtually implemented in the CPU 150, not all of the processors is needed to be always operated in the CPU 150 as long as only the processor needed to be processed is virtually implemented.

Furthermore, the image transmission program 170a does not always needs to be stored in the HDD 170 or the ROM 160 from the beginning. For example, each program may be stored in a “portable physical medium” such as a flexible disk, known as an FD, a CD-ROM, a DVD disk, a magneto optical disk or an IC card, that is to be inserted into the computer 100. Then, the computer 100 may obtain and execute each program from the portable physical medium. Furthermore, each program may be stored in another computer, a server device, or the like that is connected to the computer 100 through a public line, the Internet, LAN, WAN or the like, and the computer 100 may obtain each program from the other computer or the server device and execute the program.

According to an aspect of the information processing device disclosed in the present invention, an advantage is provided in that reduction efficiency of the amount of data transmission can be improved while reducing the processing load.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
an image memory that stores therein an image to be displayed on a terminal device that is connected through a network; and
a processor coupled to the image memory, wherein the processor executes a process comprising:
drawing a processing result from software into the image memory;
detecting an update area containing an update between frames in an image drawn in the image memory;
performing still image compression on an image in the update area by using one of a compression format from among multiple compression formats;
identifying a high-frequency change area in which a frequency of changes between the frames in the image drawn in the image memory exceeds a predetermined frequency;
performing moving image compression, from among images drawn in the image memory, on an image in the high-frequency change area;
transmitting still image compressed data in the update area and moving image compressed data in the high-frequency change area to the terminal device;
attempting to change a compression format used at the still image compression when compression of a moving image ends at the moving image compression; and
selecting a compression format used at the still image compression based on the result of comparing a compression ratio of still image compressed data in update areas obtained, at the attempting, before and after a change in a compression format.

2. The information processing device according to claim 1, wherein
the attempting includes attempting to change the compression format when a change between a compression ratio of still image compressed data in an update area of a frame and a compression ratio of still image compressed data in an update area of another frame previous to the frame is equal to or greater than a predetermined threshold.

3. The information processing device according to claim 1, wherein
the attempting includes attempting to change the compression format when a change between an area of an update area detected and an area of a previous frame that is obtained before the update area has been detected is within a predetermined range.

4. The information processing device according to claim 1, wherein
the attempting includes attempting to change the compression format based on the result of comparing the number of colors contained in an image in an update area detected and a predetermined threshold.

5. The information processing device according to claims 1, wherein
the attempting includes attempting to change the compression format when an image in an overwrite area, in which a high-frequency change area that is to be overwritten and that receives moving image compressed data transmitted when a moving image is being compressed, is subjected to the still image compression.

6. An image transmission method comprising:
drawing, using a processor, a processing result from software into an image memory that stores therein an image to be displayed on a terminal device that is connected through a network;
detecting, using the processor, an update area containing an update between frames in an image drawn in the image memory;
performing, using the processor, still image compression on an image in the update area by using one of a compression format from among multiple compression formats;
identifying, using the processor, a high-frequency change area in which a frequency of changes between the frames in the image drawn in the image memory exceeds a predetermined frequency;
performing, using the processor, moving image compression, from among images drawn in the image memory, on an image in the high-frequency change area;
transmitting, using the processor, still image compressed data in the update area and moving image compressed data in the high-frequency change area to the terminal device;
attempting, using the processor, to change a compression format used at the still image compression when compression of a moving image ends at the moving image compression; and
selecting, using the processor, a compression format used at the still image compression based on the result of comparing a compression ratio of still image compressed data in update areas obtained, at the attempting, before and after a change in a compression format.

7. A computer readable recording medium having stored therein an image transmission program causing a computer to execute a process comprising:
drawing a processing result from software into an image memory that stores therein an image to be displayed on a terminal device that is connected through a network;
detecting an update area containing an update between frames in an image drawn in the image memory;
performing still image compression on an image in the update area by using one of a compression format from among multiple compression formats;
identifying a high-frequency change area in which a frequency of changes between the frames in the image drawn in the image memory exceeds a predetermined frequency;
performing moving image compression, from among images drawn in the image memory, on an image in the high-frequency change area;
transmitting still image compressed data in the update area and moving image compressed data in the high-frequency change area to the terminal device;
attempting to change a compression format used at the still image compression when compression of a moving image ends at the moving image compression; and
selecting a compression format used at the still image compression based on the result of comparing a compression ratio of still image compressed data in update areas obtained, at the attempting, before and after a change in a compression format.
